(19) United States
(12) Patent Application Publication
(10) Pub. No.: US 2012/0206488 A1
(43) Pub. Date: Aug. 16, 2012

(54) ELECTRONIC DEVICE WITH A GRAPHIC FEATURE

(76) Inventors: Glenn WONG, Foster City, CA (US); Kevin Massaro, Houston, TX (US); Mark C. Solomon, San Jose, CA (US)

(21) Appl. No.: 13/028,989

(22) Filed: Feb. 16, 2011

(51) Int. Cl. G09G 5/00

(52) U.S. Cl. 345/649

(57) ABSTRACT

An electronic device having a graphic feature which is separate from a display device, wherein the graphic feature is configured to be activated in response to a change in orientation of the electronic device and then deactivated after a period of time.

### BACKGROUND

An electronic device such as a portable computer can include an orientation detector that can detect the orientation of the device. The portable computer can also include a display device for displaying information such as content including text, video, graphics and the like. The device can detect a change in the orientation of the device and display information in an upright manner relative to the user independent of the orientation of the device.

### BRIEF DESCRIPTION OF THE DRAWINGS

For a detailed description of example embodiments, reference will now be made to the accompanying drawings in which:

FIGS. 1A, 1B and 1C are diagrams of an electronic device with graphic features in different orientations in accordance with at least some illustrative embodiments;

FIG. 2 is a block diagram of an electronic device with graphic features in accordance with at least some illustrative embodiments; and

FIG. 3 is a flow chart of a method of operation of an electronic device with graphic features in accordance with at least some illustrative embodiments.

### DETAILED DESCRIPTION

Disclosed is an embodiment of an electronic device such as a portable computer which may include a display device and a graphic feature that is separate from the display device. The graphic feature can be activated and deactivated based on the orientation of the device. For example, a graphic feature can include an illuminating logo that can be activated (turned on or illuminated) based on the orientation (vertical or horizontal) of the device. Further, the graphic feature can be deactivated (turned off or not illuminated) in a gradual manner when information such as, video content, is being viewed on the display device. In this manner, the content can be viewed without being distracted by the otherwise illuminated graphic feature. In addition, inactivating the graphic feature after a period of time may help reduce the power consumption of the electronic device.

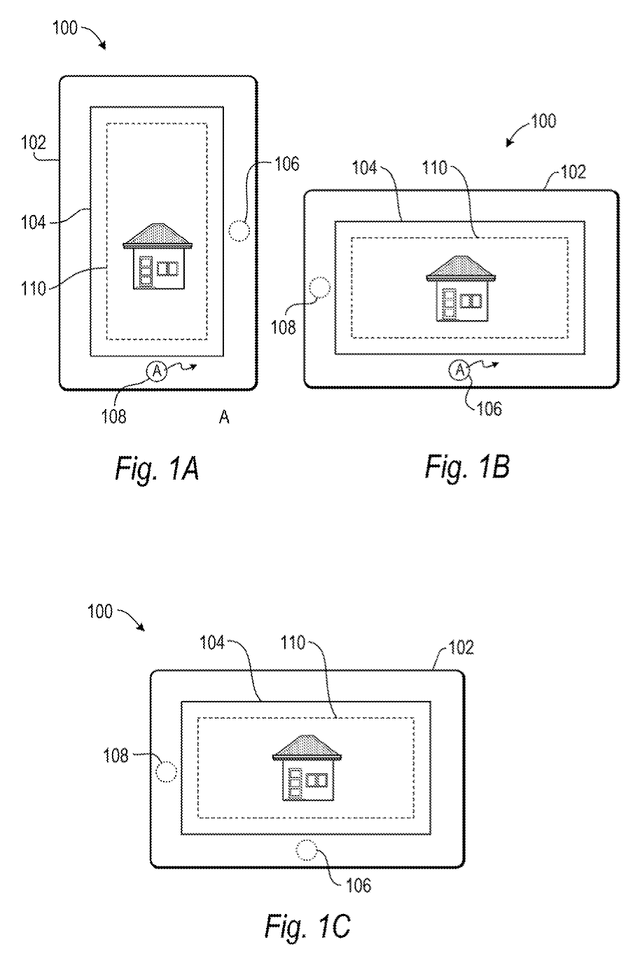

Various embodiments and the advantages thereof are best understood by referring to FIGS. 1A-1C, 2 and 3 like numerals being used for like and corresponding parts of the various drawings.

FIG. 1A shows a portable electronic device 100 having a housing 102 to support a first graphic feature 106 and a second graphic feature 108 capable of being activated and deactivated in response to change in the orientation of the device in accordance with an embodiment.

The electronic device 100 includes a display device 104 for displaying information such as content including video, text, graphic and the like. The electronic device 100 can include an input device 110 such as a touch sensitive device configured to detect touch input. In some embodiments, the touch sensitive device which can be integrated with the display device to allow electronic device 100 to detect input for further processing. The input device 110 is shown as overlaying display device 104 for illustrative purposes. It should be understood that the input device 110 can be disposed on other, portions of electronic device, separate as wireless or wired connection, or a combination thereof. The input device 110 is shown as a touch sensitive device but can be any input device including a keyboard, mouse, touch pad, voice recognition and the like. The electronic device 100 is shown as a tablet computer with a combination display and touch screen. However, it should be understood that electronic device 100 can be any type of portable electronic device such as a laptop computer, notebook computer (having a base unit with a keyboard and a display unit with display device configured as a clamshell form), mobile phone, smart phone, personal digital assistance (PDA) and the like.

In some embodiments, graphic features 106, 108 can be any electronic component or device capable of being activated (turned on to illuminate) and deactivated (turned off to not illuminate). The graphic features can be electronic devices that can display information such as an icon, logo, badge, symbol, characters and the like. For example, the graphic features can be illumination logos that can display text, graphic, video and the like. Although two graphic features are shown, it should be understood that a different number of graphic features can be employed with device 100. The first graphic feature 106 is shown disposed along one edge or side of display device 104 and second graphic feature 108 is shown along another side or edge of display device. However, it should be understood that graphic features 106, 108 can be disposed along different sides or edges of display device 104. Graphic features 106, 108 are shown as being physically separate from display device 104 and residing on the front face of device 100. It should be understood that one or more of graphic features 106, 108 can be disposed on the rear or opposite side of device 100. The device 100 controls graphic features 106, 108 to display information independent (or distinct from) of information displayed on display device 104.

To illustrate operation, FIG. 1A shows electronic device 100 in a first orientation (vertical or portrait position) and with first graphic feature 106 as being inactivated (turned off as shown by the dashed line circle) and second graphic feature 108 as being activated (turned on as shown by the solid lines and jagged arrow). The second graphic feature 108 is shown as displaying a graphic character “A” displayed in an upright manner relative to a user. In a similar manner, display device 104 shows content (for example an image of a house) in an upright manner relative to a user. It should be understood that the image shown on display device 104 and graphic features 106, 108 are for illustrative purposes and electronic device is capable of displaying other content.

FIG. 1B shows electronic device 100 after being rotated clockwise from the first orientation shown in FIG. 1A (vertical or portrait position) to a second orientation (horizontal or landscape position). As a result of this change in rotation or orientation, electronic device activates first graphic feature 106 (turned on as shown by the solid lines and jagged arrow) and deactivates second graphic feature 108 (turned off as shown by the dashed line circle). That is, first graphic feature 106 is shown as displaying a graphic character “A” displayed in an upright manner relative to a user. In a similar manner, electronic device 100 changes the orientation of content on display 104 (for example an image of a house) in an upright manner relative to a user. Thus, electronic device 100 can activate graphic features 106, 108 and display content to display in an upright manner based on changes in the orientation of the electronic device. FIG. 1B shows that electronic device 100 can control graphic features 106, 108 and display device 104 based on changes in orientation in a clockwise manner for illustrative purposes. However, it should be understood that electronic device 100 can control graphic features 106, 108 and display device 104, based on changes other than clockwise orientation such as counterclockwise and the like.

FIG. 1C shows electronic device 100 having inactivated first graphic feature 106 after a period of time. For example, electronic device can be configured to deactivate graphic feature 106 in a gradual manner (reduction in amount of illumination) to produce a fading out effect. The period of time can be based on several factors such as information being displayed on display device 104 or other criteria. For example, first graphic feature 106 no longer displays the graphic character “A” as represented by the dashed line circle. In addition, display 104 continues to shows content (for example the image of the house) in an upright manner relative to a user. In this manner, the graphic features are inactivated when no longer necessary which can help reduce power consumption of electronic device. Furthermore, a user can view information on display device 104 without being distracted by graphic features 106, 108 being activated (illuminated).

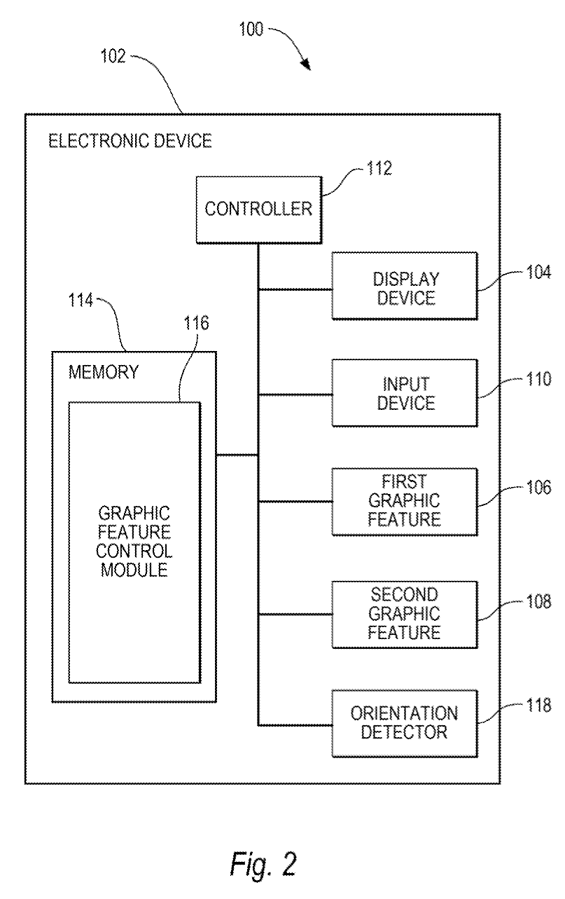

FIG. 2 is a block diagram of electronic device 100 with graphic features 106, 108 in accordance with at least some illustrative embodiments. The electronic device 100 can include a controller 112 capable of executing software instructions in memory 114 to control the operation of electronic device. For example, memory 114 can store graphic feature control module 116 which includes instructions or functionality to control operation of graphic features 106, 108. The control module 116 operates in conjunction with orientation detector 118 which can be any device capable of detecting changes in the orientation or position of device 100 and reporting such changes to control module. For example, orientation detector 118 can be an accelerometer or any mechanism in hardware, software or combination thereof for providing information or generating signals regarding changes in the orientation of device 100. The control module 116 can process such signals to control the activation and deactivation of graphic features 106, 108 as well as the orientation of content being displayed on display device 104. The controller 112 can execute software instructions in memory 114 to process input from input device 110 and control output on display device 104.

The display device 104 can include a display controller (not shown) which can be integrated with controller 112 or it may be a separate component. The display controller can be configured to process display commands to produce text and graphics on a display screen of display device 104. By way of example, display device 104 may be a liquid crystal display (LCD) monochrome display, color graphics adapter (CGA) display, enhanced graphics adapter (EGA) display, variable-graphics-array (VGA) display, super VGA display, liquid crystal display (e.g., active matrix, passive matrix and the like), cathode ray tube (CRT), plasma displays and the like.

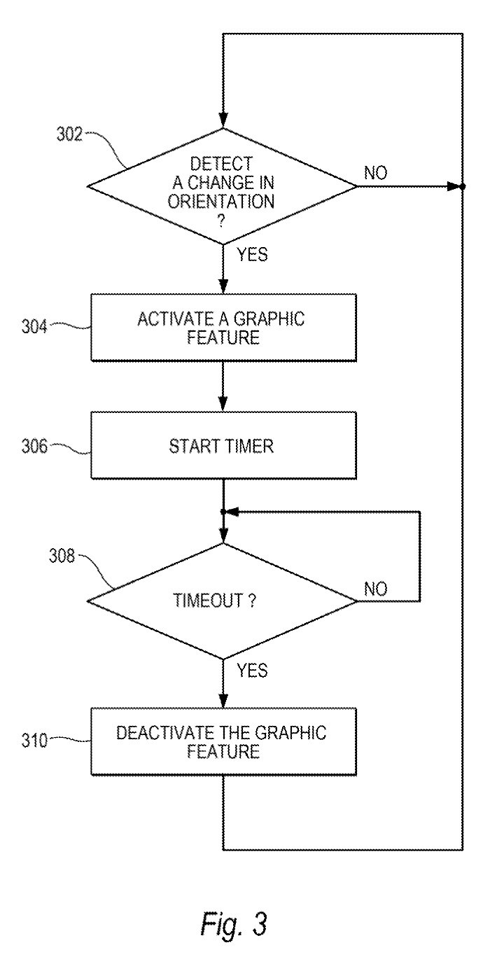

FIG. 3 shows a flow diagram of a method of controlling graphic features in electronic device 100 in accordance with an embodiment. Though depicted sequentially as a matter of convenience, at least some of the actions shown can be performed in a different order and/or performed in parallel. Additionally, some embodiments may perform only some of the actions shown. In the embodiment illustrated in FIG. 3, the method begins by assuming that electronic device 100 is initially in the vertical position as shown in FIG. 1A. It is further assumed that electronic device has inactivated first graphic feature 106, activated second graphic feature 108 and displayed on display device 104 information such as video content in an upright manner relative to a user, such as shown in FIG. 1A.

The method proceeds to block 302 which includes having electronic device 100 monitor for changes in the orientation or position of electronic device. In one example, orientation detector 118 monitors for changes in the orientation of electronic device 100 and generates signals based on such changes for further processing. If there is no change in the orientation of electronic device 100, then the method proceeds back to block 302 to continue to monitor for changes in the orientation of the electronic device. On the other hand, if there is a change in the orientation of electronic device 100, then processing proceeds to block 304 as explained below in further detail. For example, it is assumed that electronic device 100 is rotated clockwise from the first orientation shown in FIG. 1A (vertical or portrait position) to a second orientation (horizontal or landscape position) as shown in FIG. 1B. In this example, orientation detector 118 detects such changes in orientation and generates signals to control module 116 for further processing. For example, control module 116 processes these signals to control the activation and deactivation of graphic features 106, 108 and control orientation of content on display device 104 as explained in further detail below.

At block 304, electronic device 100 processes the changes in orientation of electronic device to control graphic features 106, 108 and orientation of content on display device 104. For example, it is assumed that the orientation of device 100 changed from a first orientation (vertical or portrait position as shown in FIG. 1A) to a second orientation (horizontal or landscape position as shown in FIG. 1B). Control module 116 can process the change in orientation by activating first graphic feature 106 (turned on as shown by the solid lines and logo being visible shown by the jagged arrow) and deactivating second graphic feature 108 (turned off as shown by the dashed line circle and the logo no longer being visible). The control module 116 further changes the orientation of the displayed content (for example the image of a house) on display device 104 to be in the upright manner for proper viewing by the user as shown in FIG. 1B

Processing proceeds to block 306, wherein electronic device initiates a timer with a time period for use in deactivating first graphic feature 106 after the expiration of the time period. The timer function as well as the time period can be implemented in hardware, software or a combination thereof. The time period can be selected automatically based on various factors such as the content being displayed on display or any other criteria. The time period can also be manually selected by a user or other means and can be set to any value desired.

Processing proceeds to block 308, wherein electronic device 100 checks whether the time period for deactivation has elapsed. In one embodiment, control module 116 can check whether the time period has elapsed. If the time period has not elapsed, then processing proceeds back to block 308 to continue to monitor or wait for the elapse of the time period. On the other hand, if it is determined that the time period has elapsed, then processing proceeds to block 310, as explained below.

At block 310, electronic device 100 deactivates first graphic feature 106 after the elapse of the time period for deactivation. For example, control module 116 can deactivate first graphic feature 106 (as shown by the dashed line circle and the logo no longer being displayed), as shown in FIG. 1C. Further, control module 116 can continue to display on display device 104 content (for example the image of the house) in an upright manner relative to a user. In this manner, graphic features 106, 108 can be inactivated after a period of time which can help reduce power consumption of electronic device. Furthermore, a user can view information on display device 104 without being distracted by graphic features 106, 108 being activated (illuminated).

In one embodiment, electronic device 100 may correspond to a media player. The media player may include a computing device capable of processing content or media such as audio, video or other images, including, for example, music player, game player, video player, video recorder and the like. Such a device may be portable which may allow a user to, for example, listen to music, play games or video, record video or take pictures wherever the user travels. The electronic device may include connection capabilities that allow a user to upload and download data to and from a host device, such as a general purpose computer such as a desktop computer.

In one embodiment, the functionality of electronic device 100 (and control module 116) can be implemented in software, as an executable program, and executable by a processor. In one embodiment, such functionality can be implemented in hardware which can be any combination of the following technologies which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA) and the like.

Although not shown to simplify the drawings, electronic device 100 can include a processor, memory and input/output (I/O) devices capable of communication via a local interface. The local interface can be, for example but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include addresses, controls, and/or data connections to enable appropriate communications among the aforementioned components.

The processor can be any hardware device for executing software, particularly that stored in memory. The processor can be any custom made or commercially available processor, a central processing unit (CPU), an auxiliary processor among several processors associated with electronic device 100, a semiconductor based microprocessor (in the form of a microchip or chip set), a macroprocessor, or generally any device for executing software instructions. The I/O devices may include input devices, for example but not limited to, a keyboard, mouse, scanner, microphone, touch pad, touch screen, voice input and the like. Furthermore, the I/O devices may also include output devices, for example but not limited to, a printer, display, etc. Finally, the I/O devices may further include devices that communicate both inputs and outputs, for instance but not limited to, a modulator/demodulator (modem; for accessing another device, system, or network), a radio frequency (RF) device or other transceiver, a telephonic interface, a bridge, a router, etc. The memory can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory may incorporate electronic, magnetic, optical, and/or other types of storage media. The memory can have a distributed architecture, where various components are situated remote from one another, but can be accessed by the processor.

The software in memory may include one or more separate programs, each of which comprises an ordered listing of executable instructions for implementing logical functions. The software in the memory may include software to implement host wireless module and remote wireless module as well as an operating system (O/S). The OS can control the execution of other computer programs, such as those of control module 116, and provide scheduling, input-output control, file and data management, memory management, and communication control and related services. The control module 116 can include source program, executable program (object code), script, or any other entity comprising a set of instructions to be performed. When it is a source program, then the program needs to be translated via a compiler, assembler, interpreter, or the like, which may or may not be included within the memory, so as operate properly in connection with the O/S. Furthermore, control module 116 can be written as (a) an object oriented programming language, which has classes of data and methods, or (b) a procedure programming language, which has routines, subroutines, and/or functions, for example but not limited to, C, C++ and Java. In some embodiments, the software in memory may further include a basic input output system (BIOS). The BIOS can include a set of essential software routines that initialize and test hardware at startup, start the O/S, and support the transfer of data among the hardware devices. The BIOS can be stored in ROM so that the BIOS can be executed when electronic device 100 is activated.

When electronic device 100 is in operation, the processor can be configured to execute software stored within the memory, to communicate data to and from the memory, and to generally control operations of electronic device 100 pursuant to the software. The control module 116 and the O/S, in whole or in part, but typically the latter, can be read by the processor, perhaps buffered within the processor, and then executed.

When control module 116 is implemented in software, the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The control module 116 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An electronic device comprising:
a graphic feature which is separate from a display device and configured to be activated in response to a change in orientation of the electronic device and then deactivated after a period of time.

2. The device of claim 1, wherein the graphic feature comprises an electronic device configured to illuminate.

3. The device of claim 1, wherein the graphic feature is configured to display information in an upright manner independent of the orientation of the device.

4. The device of claim 1, wherein the graphic feature is configured to display information independent of information displayed on the display device.

5. The device of claim 1, wherein the graphic feature is configured to be deactivated by a gradual reduction in amount of illumination.

6. The device of claim 1, further comprising an orientation detector configured to detect the change in orientation of the electronic device.

7. The device of claim 1, wherein the graphic feature comprises a graphic feature disposed about an edge of the display device and another graphic feature disposed about another edge of the display device.

8. The device of claim 1, wherein the graphic feature comprises a graphic feature configured to be activated when the electronic device is positioned in one orientation and another graphic feature configured to be activated when the electronic device is positioned in another orientation.

9. The device of claim 1, further comprising an input device having a touch surface configured to receive touch input.

10. The device of claim 1, wherein the graphic feature and the display device have a viewing surface facing substantially along a same side.

11. A method of controlling a graphic feature comprising:
providing a graphic feature on an electronic device, the graphic feature being separate from a display device for displaying information;
activating the graphic feature in response to detection of a change in orientation of the device; and
deactivating the graphic feature after a period of time.

12. The method of claim 11, further comprising detecting touch input via a touch device having a touch sensitive surface.

13. The method of claim 11, wherein deactivating the graphic feature includes reducing amount of illumination in a gradual manner.

14. The method of claim 11, wherein activating the graphic feature includes having the graphic feature display information in an upright manner independent of the orientation of the electronic device.

15. The method of claim 11, wherein activating the graphic feature includes having the graphic feature display information independent of information displayed on the display device.

16. A computer-readable medium storing instructions that, when executed by an electronic device, causes the electronic device to:
display information on a display device;
activate a graphic feature separate from the displayed information in response to detection of a change in orientation of the electronic device; and
deactivate the graphic feature after a period of time.

17. The computer-readable medium of claim 16, further including instructions which when executed cause the electronic device to detect touch input from a touch surface.

18. The computer-readable medium of claim 16, further including instructions which when executed cause the electronic device to deactivate the graphic feature by reducing amount of illumination in a gradual manner.

19. The computer-readable medium of claim 16, further including instructions which when executed cause the electronic device to activate the graphic feature by having the graphic feature display information in an upright manner independent of the orientation of the device.

20. The computer-readable medium of claim 16, further including instructions which when executed cause the electronic device to activate the graphic feature by having the graphic feature display information independent of the information displayed on the display device.
